(19) United States
(12) Patent Application Publication
(10) Pub. No.: US 2009/0105107 A1
(43) Pub. Date: Apr. 23, 2009

(54) Care Composition

(76) Inventors: Andrew Paul Chapple, Wirral (GB); Joachim Lienke, Vlaardingen (NL); Lucas Gerard Grabijn, Vlaardingen (JP)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/087,626

(22) PCT Filed: Nov. 28, 2006
(86) PCT No.: PCT/EP2006/011475

§ 371 Date: Nov. 13, 2008

(30) Foreign Application Priority Data
Jan. 13, 2006 (GB) 0600644.9

(51) Int. Cl. C11D 3/20

(52) U.S. Cl. 510/302

(57) ABSTRACT

The present invention provides antioxidants that are readily deposited on elastomers and are also more stable in formulation that monophenolic species.

### FIELD OF INVENTION

This invention relates to the treatment of cured polymers that are used in textiles.

### BACKGROUND OF INVENTION

The use of polymer fibers in clothing is ubiquitous. The use of polybutadiene binders in the clothing industry is widespread to permit the printing of images on clothing. The use of natural rubber (a natural polymer) is also found in the waistband of many garments.

Elastane is a commonly used man-made fibre that is used on its own or in mixture with natural fibres for the manufacture of clothing. Elastane fibres, better known under their trade names, Lycra and Dorlastan, are widely commercially available. Elastane was invented in 1937 in Germany and has properties not found in nature, the most important being an extraordinary elasticity. The majority of contour fitting swimming costumes contain elastane.

Elastane fibres can be stretched from four to seven times their length, reverting to their original length when the tension is relaxed. Elastane has the highest stretch tension of all textile raw materials. Two percent elastane is enough to make trousers, for instance, retain their shape. For body-shaped silhouette and high stretch capacity, i.e. in swimwear, corsetry or sportswear, 15 to 40% elastane is used. Elastane fibres provide a high degree of comfort combined with great freedom of movement. In woven and knitted fabrics elastane increases shape retention and accelerates crease recovery.

The aforementioned polymers are also susceptible to degradation. One apparent aspect to their degradation of these polymer containing garments is that that when failure occurs it occurs over a relatively short period of time in the garments lifetime. Another example of failure is where the print binder degrades such that flaking and cracking of the print occurs of because of degradation of the binder.

Aggravating factors that contribute to the loss of integrity of these polymers are, for example, hypochlorites, ozone, sunlight (ultraviolet light), singlet and triplet oxygen.

The fact that many swimming pools contain hypochlorite results in the diminished lifetime of many a swimming costume.

### SUMMARY OF INVENTION

The present invention has particular utility in treating polymers which are elastomeric. In this regard, an elastomer is defined as a polymer that is capable of being stretched to at least twice its original rest length whilst remaining within its elastic limit, i.e., without undergoing plastic deformation.

In one embodiment the present invention provides a laundry treatment composition comprising between 0.0001 to 0.1 wt % of an antioxidant, the antioxidant of the structure (I):

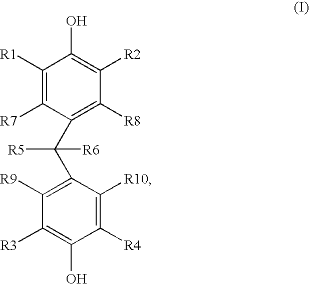

wherein R1, R2, R3, R4, R5 and R6 are independently selected from: —CH3, —C2H5, —C3H7, —C4H9, and —C5H11; and R7, R8, R9, R10 and R10 are independently selected from: H, —CH3, —C2H5, —C3H7, —C4H9, and —C5H11, and between 2 to 60 wt % of a surfactant.

With regard to the defined antioxidant: It is preferred that R1=R2=R3=R4. It is preferred that R5=R6. It is preferred that R7=R8=R9=R10=H. It is preferred that R1, R2, R3, and R4, are selected from: —CH3 and t-Bu. It is preferred that R5 and R6 are -Me.

In another embodiment the present invention provides a method of treating a textile, the method comprising the steps of:
(i) treating a textile with an aqueous solution of the antioxidant, the aqueous solution comprising from 0.01 to 1000 ppm of the antioxidant and from 0.2 g/L to 3 g/L of a surfactant; and,
(ii) rinsing and drying the textile.

The present invention provides use of a composition for increasing the integrity lifetime of an apolar cured elastomeric polymer substrate, the use by applying to the apolar cured elastomeric polymer substrate an antioxidant in an aqueous medium, wherein the apolar substrate forms part or whole of a textile garment (an article of clothing). The present invention is preferably applied to an article of clothing that has been worn at least once and is solid.

By providing a method of treating a garment that consists of or comprises a stretchy polymer the user may choose to treat the garment repeatedly during its lifetime thereby maintaining the garment. This provides an advantage over mere treatment of the polymer before manufacture into a garment. In addition, the present method inhibits the yellowing of the polymer substrates.

The present invention has additional utility because of additional stability of the specific antioxidants in formulations.

The present invention also extends to a commercial package together with instructions for its use.

### DETAILED DESCRIPTION OF THE INVENTION

### Antioxidant

The level of the antioxidant in an aqueous solution is 0.01 to 1000 ppm, preferably 0.1 to 100 ppm, most preferably 0.1 to 50 ppm. This level is achieved by dosing an aqueous medium with a composition comprising the antioxidant such that a unit dose provides the desired level in the aqueous medium.

Anti-oxidants are substances as described in Kirk-Othmers (Vol 3, pg 424) and in Uhlmans Encyclopedia (Vol 3, pg 91) and CRC Press Oxidation Inhibition in Organic Materials Vols I and II, Eds. Jan Pospisil and Peter P. Klemchuk: ISBN 0-8493-4767-X and 0-8493-4768-8.

### Balance Carriers and Adjunct Ingredients

These may be surfactants, builders, foam agents, anti-foam agents, solvents, peroxygen bleaches, catalysts, and enzymes. The use and amounts of these components are such that the composition performs well depending upon economics, environmental factors and use of the composition.

The composition comprises a surfactant and optionally other conventional detergent ingredients. The composition may also comprise an enzymatic detergent composition which comprises from 0.1-50% by weight, based on the total detergent composition, of one or more surfactants. This surfactant system may in turn comprise 0-95% by weight of one or more anionic surfactants and 5 to 100% by weight of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2%.

It is preferred that the composition comprises between 2 to 60 wt % of a surfactant. In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates and sodium C₁₂-C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆-C₁₈ primary alcohol sulphate and/or LAS together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

It is preferred that laundry treatment composition and method comprise a builder. The builder in the composition is preferably in the range from about 5 to 80% by weight, preferably from about 10 to 60% by weight. The builder in the method is preferably is present in the range from 0.1 to 5 g/L.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate; nitrilotriacetic acid and its water-soluble salts; the alkali metal salts of carboxymethyloxy succinic acid, ethylene diamine tetraacetic acid, oxydisuccinic acid, mellitic acid, benzene polycarboxylic acids, citric acid; and polyacetal carboxylates as disclosed in U.S. Pat. No. 4,144,226 and U.S. Pat. No. 4,146,495.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

In particular, the compositions of the invention may contain any one of the organic and inorganic builder materials, though, for environmental reasons, phosphate builders are preferably omitted or only used in very small amounts. Typical builders usable in the present invention are, for example, sodium carbonate, calcite/carbonate, the sodium salt of nitrilotriacetic acid, sodium citrate, carboxymethyloxy malonate, carboxymethyloxy succinate and water-insoluble crystalline or amorphous aluminosilicate builder materials, each of which can be used as the main builder, either alone or in admixture with minor amounts of other builders or polymers as co-builder.

It is most preferred that the builder is selected from the group consisting of: sodium tripolyphosphate, carbonate, sodium silicate and zeolite 4A and zeolite maximum aluminium P.

The composition may contain peroxygen (e.g., perborate or percarbonate) bleaches and activators, e.g., TAED. The composition may also contain transition metal catalysts that are employed in “air mode” or “peroxyl mode” as detailed widely in the prior art.

### Cationic Compound

When the present invention is used as a fabric conditioner it needs to contain a cationic compound.

Most preferred are quaternary ammonium compounds.

It is advantageous if the quaternary ammonium compound is a quaternary ammonium compound having at least one C₁₂-C₂₂ alkyl chain.

It is preferred if the quaternary ammonium compound has the following formula:

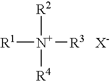

in which R¹ is a C₁₂ to C₂₂ alkyl or alkenyl chain; R², R³ and R⁴ are independently selected from C₁-C₄ alkyl chains and X⁻ is a compatible anion. A preferred compound of this type is the quaternary ammonium compound cetyl trimethyl quaternary ammonium bromide.

A second class of materials for use with the present invention are the quaternary ammonium compound having the following formula:

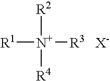

in which R¹ and R² are independently selected from C₁₂ to C₂₂ alkyl or alkenyl chain; R³ and R⁴ are independently selected from C₁-C₄ alkyl chains and X⁻ is a compatible anion. A detergent composition according to claim 1 in which the ratio of (ii) cationic material to (iv) anionic surfactant is at least 2:1.

Other suitable quatenary ammonium compounds are disclosed in EP 0 239 910 (Procter and Gamble).

It is preferred if the ratio of cationic to nonionic surfactant is from 1:100 to 50:50, more preferably 1:50 to 20:50.

The cationic compound may be present from 0.02 wt % to 20 wt % of the total weight of the composition.

Preferably the cationic compound may be present from 0.05 wt % to 15 wt %, a more preferred composition range is from 0.2 wt % to 5 wt %, and most preferably the composition range is from 0.4 wt % to 2.5 wt % of the total weight of the composition.

If the product is a liquid it is preferred if the level of cationic surfactant is from 0.05 wt % to 10 wt % of the total weight of the composition. Preferably the cationic compound may be present from 0.2 wt % to 5 wt %, and most preferably from 0.4 wt % to 2.5 wt % of the total weight of the composition.

If the product is a solid it is preferred if the level of cationic surfactant is 0.05 wt % to 15 wt % of the total weight of the composition. A more preferred composition range is from 0.2 wt % to 10 wt %, and the most preferred composition range is from 0.9 wt % to 3.0 wt % of the total weight of the composition.

### Experimental

A synthetic elastomeric fibre was chosen containing 20% elastane, a segmented block copolymer, based on polyurethane (hard segment) and poly-ester or poly-ether (soft segment). The fabric was co-spun with 80% nylon. This fabric was either used without any pre-treatment (fabric 1) or pre-irradiated in natural sunlight up to a total irradiation level of 10 MJ/m2 (fabric 2). This requires typically 10 full days of outside line-drying in regions with high UV irradiation.

Both fabrics were washed in cycles of four washes followed by an overnight irradiation. Washes were carried out in a Top Loader Automatic machine at ambient temperature with an intake of 45 l 2° FH (2:1 Ca:Mg) water. A ballast load of 1.5 kg desized cotton was included. 1.5 g/l Brazilian OMO MA™ was dosed containing no antioxidant (control), 0.02% 2,6-tert-butyl-4-methylphenol (BHT) or 0.02% 4,4′-Isoproylidenebis(2,6-dimethylphenol) (IPDMP) (CAS 5613-46-7). Irradiation was carried out in sunbeds with an UV intensity of about 20 W/m2. Total duration of the irradiation was 12 hours with intervals of 30 minutes with 15 minutes irradiation followed by a resting phase of 15 minutes.

Test fabrics were regularly monitored for mechanically failure, i.e. loss of elasticity due to braking of the elastomeric fibres. Additionally the total antioxidant level was quantified after 6 cycles (24 washes and 6 irradiation cycles) and for fabric 2 also at a later stage. Determination was done by extracting the antioxidant in ethanol followed by spectrophotometric determination using an assay described by C. Rice-Evans et al. (Free Radical Biol. & Med., 26 (9/10), 1231-1237 (1999)).

The test results show that both antioxidants delay natural ageing of the elastomeric fibre, however, IBDMP is much more efficient as it builds up high concentrations of protective antioxidant under conditions of severe oxidative stress (table 1 and 2).

TABLE 1
Protection on new fabric (fabric 1).

| | Antioxidant level | |
|---|---|---|
| | after 6 cycle | |
| Condition | (mmol/kg) | Mechanical failure |
| New fabric | 3.0 * | |
| Control | 1.3 | 25 cycles |
| BHT | 2.2 | >30 cycles |
| IBDMP | 2.7 | >30 cycles |

* not washed

TABLE 2
Protection on pre-irradiated fabric (fabric 2).

| | | | |
|---|---|---|---|
| | Antioxidant | Antioxidant | |
| | level | level (mmol/kg) | |
| | (mmol/kg) | by failure or | Mechanical |
| Condition | after 6 cycle | 26 cycles | failure |

| | | | | |
|---|---|---|---|---|
| New fabric | 0.2 * | | | |
| Control | 0.04 | 0 | (17 cycles) | 17 cycles |
| BHT | 0.1 | 0.2 | (27 cycles) | >30 cycles |
| IBDMP | 1.6 | 1.0 | (27 cycles) | >30 cycles |

* not washed

### Stability

1) 0.44 g of 2,6-Di-tert-butyl-4-methylphenol was dissolved in 50 g of ethanol.

5 g of the ethanolic anti-oxidant solution was then sprayed onto 100 g of detergent powder in a rotating drum apparatus. The resulting powder was spread thinly on a tray and left in the open atmosphere for 60 minutes for the ethanol to evaporate.

2) As for (1) with 0.525 g of 2,4,6-Tri-tert-butylphenol in 50 g ethanol, replacing 0.44 g of 2,6-Di-tert-butyl-4-methylphenol dissolved in 50 g of ethanol.

3) As for (1) with 0.413 g of 2,6-Di-tert-butylphenol in 50 g ethanol, replacing 0.44 g of 2,6-Di-tert-butyl-4-methylphenol dissolved in 50 g of ethanol.

4) As for (1) with 0.272 g of 2,4,6-Trimethylphenol in 50 g ethanol, replacing 0.44 g of 2,6-Di-tert-butyl-4-methylphenol dissolved in 50 g of ethanol.

5) As for (1) with 0.525 g of 2,6-Di-tert-butyl-4-sec-butylphenol in 50 g ethanol, replacing 0.44 g of 2,6-Di-tert-butyl-4-methylphenol dissolved in 50 g of ethanol.

6) As for (1) with 0.525 g of 2,6-Di-tert-butyl-4-ethylphenol in 50 g ethanol, replacing 0.44 g of 2,6-Di-tert-butyl-4-methylphenol dissolved in 50 g of ethanol.

7) As for (1) with 0.473 g of 3,5-Di-tert-butyl-4-hydroxyanisol in 50 g ethanol, replacing 0.44 g of 2,6-Di-tert-butyl-4-methylphenol dissolved in 50 g of ethanol.

8) As for (1) with 0.568 g of 4,4′-Isopropylidenebis(2,6-dimethylphenol) in 50 g ethanol, replacing 0.44 g of 2,6-Di-tert-butyl-4-methylphenol dissolved in 50 g of ethanol.

9) Storage Testing

Separate 7 g samples of the resulting powder were then weighed separately into 30 ml glass jars and stored open at 37° C. and 70% RH. Samples were removed from storage after 7 weeks. The stored sample was dissolved in acetonitrile, filtered and analyzed for residual anti-oxidant content by HPLC.

TABLE 3
Storage Stability Testing

| Example | | % Remaining |
|---|---|---|
| No | Anti-oxidant | (7 weeks) |
| 1 | 2,6-Di-tert-butyl-4-methylphenol | 9 |
| 2 | 2,4,6-Tri-tert-butylphenol | 28 |
| 3 | 2,6-Di-tert-butylphenol | 18 |
| 4 | 2,4,6-Trimethylphenol | 19 |
| 5 | 2,6-Di-tert-butyl-4-sec- | 32 |
| | butylphenol | |
| 6 | 2,6-Di-tert-butyl-4-ethylphenol | 22 |
| 7 | 3,5-Di-tert-butyl-4-hydroxyanisol | 0 |
| 8 | 4,4′-Isopropylidenebis(2,6- | 63 |
| | dimethylphenol) | |

1. A laundry treatment composition comprising between 0.0001 to 0.1 wt % of an antioxidant, the antioxidant of the structure (I): 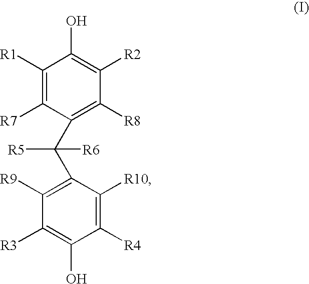
wherein R1, R2, R3, R4, R5 and R6 are independently selected from: —CH3, —C2H5, —C3H7, —C4H9, and —C5H11; and
R7, R8, R9, R10 and R10 are independently selected from: H, —CH3, —C2H5, —C3H7, —C4H9, and —C5H11,
and between 2 to 60 wt % of a surfactant.

2. A laundry treatment composition according to claim 1, wherein R1=R2=R3=R4.

3. A laundry treatment composition according to claim 1, wherein R5=R6.

4. A laundry treatment composition according to claim 1, wherein R7=R8=R9=R10=H.

5. A laundry treatment composition according to claim 1, wherein R1, R2, R3, and R4, are selected from: —CH3 and t-Bu.

6. A laundry treatment composition according to claim 1, wherein R5 and R6 are -Me.

7. A laundry treatment composition according to claim 1, wherein the antioxidant is 4,4′-isoproylidenebis(2,6-dimethylphenol).

8. A method of treating a textile, the method comprising the steps of:
(i) treating a textile with an aqueous solution of the antioxidant as defined in claim 1, the aqueous solution comprising from 0.01 to 1000 ppm of the antioxidant and from 0.2 g/L to 3 g/L of a surfactant; and,
(ii) rinsing and drying the textile.

9. A method of treating a textile according to claim 8, wherein the aqueous solution has an ionic strength from 0.001 to 0.5.

10. A garment treated with the method according to claim 8.
